(19) United States
(12) Patent Application Publication
(10) Pub. No.: US 2008/0216373 A1
(43) Pub. Date: Sep. 11, 2008

(54) Key tag holder

(76) Inventors: Dominic E. Rivera, Elgin, IL (US); Glenn L. Rivera, Wooddale, IL (US)

Correspondence Address: LAW OFFICE OF JOHN W. HARBST, 1180 LITCHFIELD LANE, BARTLETT, IL, 60103, US

(21) Appl. No.: 11/714,397

(22) Filed: Mar. 6, 2007

(51) Int. Cl. G09F 3/18

(52) U.S. Cl. 40/661

(57) ABSTRACT

A key tag holder for displaying a plurality of different key tags each having a machine readable code for a particular service provider thereon. The key tag holder includes a one-piece binder having a first flexible and transparent key tag carrying section, a second flexible and transparent key tag carrying section, and a flexible joint extending along a predetermined axis and laterally disposed between the key tag carrying sections so as to allow the key tag carrying sections to be folded in overlying and generally flat relation relative to each other. Each key tag carrying section has a plurality of transparent pockets each sized to receive and accommodate one of the different key tags therewithin. Each pocket is closed about three sides and opens on a fourth side to the predetermined axis of the binder. The transparency of each pocket of the key tag carrying sections permits the machine readable code on each different key tag to be readable from either side of the pocket within which each key tag is received.

### FIELD OF THE INVENTION

The present invention relates to relatively small key tags bearing machine readable personal information thereon, including bar codes and the like, and, more particularly, to a holder for carrying and displaying a plurality of such key tags in a manner permitting ready access to any one of the plurality of key tags and the information provided thereon carried in such holder.

### BACKGROUND OF THE INVENTION

Key tags, as that term or phrase is used herein and throughout, are typically miniature versions of larger cards provided by a multitude of different service providers throughout the country. That is, key tags are commonly used by many organizations and service providers, i.e. pharmacies, health clubs, supermarkets, pet stores, book stores, and a myriad of other businesses for the identification of its customers and/or members. These type of cards or tags include but are not limited to: club cards, rewards cards, frequent shopper cards, loyalty cards, saver cards, and etc. Typically, such key tags are imprinted with a company's name and logo on a front face thereof and with a rear or second face of the tag containing machine readable personal information in the form of a bar code or the like which, when scanned, provides the service provider with important information relating to the particular user or presenter of the key tag.

Conventional key tags are of relatively small size, generally rectangular, and are usually formed from a thin plastic-like material. For example, most such key tags range in size from about 1 inch to about 1.097 inches wide and about 0.967 inches to about 2.097 inches in length. The larger size key tags range in size from about 1 inch to about 1.125 wide and about 1.5 inches to about 3.375 inches in length.

Such key tags typically have a hole punched through or otherwise provided therein. In the vast majority of such key tags, the hole has a closed margin and is arranged proximate to one end of the tag. The apertured design allows the key tag to be readily fastened to and freely hang from a key chain and/or key ring.

As is readily appreciated, and because key tags or cards are usually fabricated from relatively inexpensive materials, they are frequently torn or otherwise separated from the key chain and/or key ring from which they freely hang. The wear and tear to which such tags are subjected, as they are conjointly inserted and removed from pockets and/or purses along with the key ring/key chain during check-in and/or check-out at the service provider, usually causes such tags to quickly become separated and lost sometimes without the owner's knowledge.

Upon having recognized the key tag is missing, the owner needs to consume valuable time having to return to the service provider, complete the various forms to receive a replacement key tag, and then wait for the replacement key tag to arrive—after which the replacement key tag is again fastened and freely hangs from the key chain/key ring to again be subjected to the same wear and tear as the tag that was lost. Adding items to an already crowded key chain is not always practical. Accordingly, and although they are convenient, and in instances can save the owner money, many people do not care to use such key tags. Instead, many people end up carrying the larger cards offered by such service providers in their purse or wallet

Having such key tags freely hang from the key chain/key ring can also involve and raise serious security concerns. When automobiles are taken to various service providers, the key chain/key ring usually remains with the service provider. As such, the service provider has ready and reasonably free access to the information provided on such cards. Moreover, when parking at various automobile parking lots, key chains are frequently surrendered to allow the parking attendants to move the automobile, if required to do so. As such, the information on the key tags hanging from the key chain, which was surrendered, is readily available for retrieval without knowledge of the person giving over their keys.

Thus, there is a continuing need and desire for a key tag holder wherein key tags from any of several or multiple service providers can be conveniently stored in a secure manner and which readily permits displaying any one of the plurality of such key tags in a manner permitting ready access to the personal information provided thereon while such key tag is carried in such holder.

### SUMMARY OF THE INVENTION

In view of the above, and according to one aspect, there is provided a key tag holder for displaying and holding a plurality of different key tags each having a machine readable code for a particular service provider thereon. In one form, the key tag holder includes a generally rectangular backing sheet having generally parallel top and bottom edges, along with generally parallel side edges spaced a predetermined lateral distance apart. The backing sheet is formed from a soft, flexible and transparent plastic vinyl material. A first transparent and generally rectangular panel is arranged in overlying relation and is secured to an inner surface of the backing sheet adjacent the top, bottom and a first side edge. The first panel combines with the backing sheet to form a plurality of transparent pockets defining a first key tag carrying section for the key tag holder. Each pocket has three closed sides and a fourth side opening to a center portion of the backing sheet. Each pocket in the first key tag carrying section is configured to receive and hold a different key tag such that the machine readable code on the key tag is readable from either side of the key tag holder. A second transparent and generally rectangular panel is arranged in overlying relation and is secured to the inner surface of the backing sheet adjacent the top, bottom and a second side edge thereof. The second panel combines with the backing sheet to form a plurality of transparent pockets defining a second key tag carrying section for the key tag holder. Each pocket has three closed sides and a fourth side opening to the center portion of the backing sheet. Each pocket in the second key tag carrying section is configured to receive and hold a different key tag such that the machine readable code on the key tag received within any pocket is readable from either side of the key tag holder.

Preferably, each key tag carrying section is formed with at least three transparent pockets for holding at least three different key tags. In a preferred embodiment, each key tag carrying section is formed with an equal number of transparent pockets.

In a preferred embodiment, the backing sheet further includes an opaque area adjacent to the center portion of the backing sheet for permitting advertising indicia associated with a particular service provider to be imprinted thereon. In one form, the backing sheet and the first panel are joined to each other such that at least one pocket of the first key tag carrying section has a peripheral closed edge joined in common with a peripheral closed edge of at least one other pocket of the first key tag carrying section. In another preferred form, the backing sheet and second panel are joined to each other such that at least one pocket of the second key tag carrying section has a peripheral closed edge joined in common with a peripheral closed edge of at least one other pocket of the second key tag carrying section.

According to another aspect, there is provided a key tag holder for displaying and holding a plurality of different key tags each having a machine readable code for a particular service provider thereon. The key tag holder includes first and second key tag carrying sections joined to each other so as to allow the key tag carrying sections to be folded in overlying and generally flat relationship relative to each other. Each key tag carrying section includes a plurality of adjacent transparent pockets for receiving and holding a different key tag therein. The transparency of each pocket permits the machine readable code on each key tag to be readable from either side of the pocket within which the key tag is received. Each pocket of each key tag carrying section is sized relative to the key tags and is closed along three sides. To permit the key tag to be inserted into the pocket, a fourth side of each pocket opens to the area wherein the key tag sections are joined. As such, the key tags are inhibited from inadvertently slipping out of their pockets thereby reducing the likelihood the key tags will be lost.

Preferably, each key tag carrying section is formed with at least three transparent pockets for holding at least three different key tags. In one form, each key tag carrying section is preferably formed with an equal number of transparent pockets. In one embodiment, at least one pocket of the first key tag carrying section has a peripheral closed edge joined in common with a peripheral closed edge of at least one other pocket of the first key tag carrying section. In another preferred embodiment, at least one pocket of the second key tag carrying section has a peripheral closed edge joined in common with a peripheral closed edge of at least one other pocket of the second key tag carrying section.

In the exemplary embodiment, the key tag holder further includes a generally rectangular, flexible and transparent backing sheet which is common to both the first and second key tag carrying sections. The backing sheet has a top edge, a bottom edge, along with generally parallel side edges. The backing sheet further including an area extending between the top and bottom edges and laterally disposed proximately midway between the first and second key tag carrying sections for hingedly interconnecting the first and second key tag carrying sections to each other. In a preferred form, the inner surface of the backing sheet further includes an opaque section on the inner surface thereof for permitting advertising indicia associated with a particular service provider to be imprinted thereon.

According to another aspect, there is provided a key tag holder for readily displaying a plurality of different key tags each having a machine readable code for a particular service provider thereon. In this form, the key tag holder includes a one-piece binder having a first flexible key tag carrying section with inner and outer transparent surfaces, a second flexible key tag carrying section with inner and outer transparent surfaces, and a flexible joint extending along a predetermined axis and disposed between the first and second key tag carrying sections so as to allow the first and second key tag carrying sections to be folded in overlying and generally flat relation relative to each other. The inner surface of each key tag carrying section has a plurality of transparent pockets each sized to receive and accommodate one of the different key tags therewithin. Each pocket is closed about three sides and opens, on a fourth side, to the predetermined axis of the binder. The transparency of each pocket on the first and second key tag carrying sections permits the machine readable code on each key tag to be readable from either side of the pocket within which each key tag is received.

Preferably, each key tag carrying section is formed with at least three transparent pockets for holding at least three different key tags. In one form, the each key tag carrying section is formed with an equal number of transparent pockets. Moreover, at least one pocket of each key tag carrying section preferably has a peripheral closed edge joined in common with a peripheral closed edge of at least one other pocket of the same key tag carrying section.

In one embodiment, the key tag holder also includes a generally rectangular, flexible and transparent backing sheet which is common to both key tag carrying sections. The backing sheet has a top edge, a bottom edge, along with a pair of side edges. The backing sheet further includes an area extending between the top and bottom edges and laterally disposed proximately midway between the key tag carrying sections for hingedly interconnecting the key tag carrying sections. In a preferred embodiment, the backing sheet further includes an opaque section for permitting advertising indicia, associated with a particular service provider, to be imprinted on the key tag holder.

In view of the above, one of features of this invention relates to providing a key tag holder which allows a service provider to readily scan any one of a multitude of different key tags without having to physically remove the key tag from the holder.

Another feature of the present invention relates to a key tag holder which provides an organized way and apparatus to carry multiple key tags in a single compact folder thus avoiding having to clutter and further complicate the necessary items carried on a key chain/key ring.

Still another feature of the invention relates to a key tag holder which provides an organized way and apparatus to carry multiple key tags in a single compact folder and which allows the owner to maintain and exercise control over the vast amount of personal information contained on and which can be readily gleaned from the key tags.

Moreover, the key tag holder of the present invention provides an compact way and apparatus for carrying a multiple of smaller key tags in a single folder instead of having to use the larger cards thus creating more space in the owner's wallet, purse, or organizer.

These and other objects, aims and advantages of the present invention will become more readily apparent from the following detailed description, drawings and appended claims.

### BRIEF DESCRIPTION OF THE DRAWINGS

FIG. 1 is a perspective view of one embodiment of a key tag holder embodying principals of the present invention and shown in a partly open position;

FIG. 2 is a perspective view of one form of key tag to be carried by the key tag holder shown in FIG. 1;

FIG. 3 is a rear side view of the exemplary key tag shown in FIG. 2;

FIG. 4 is a rear side plan view of the key tag holder shown in FIG. 1;

FIG. 5 is a front side plan view of the key tag holder shown in FIG. 1;

FIG. 6 is an enlarged sectional view taken along line 6-6 of FIG. 5;

FIG. 7 is an enlarged sectional view taken along line 7-7 of FIG. 5;

FIG. 8 is an enlarged sectional view taken along line 8-8 of FIG. 5; and

FIG. 9 is a front side plan view similar to FIG. 5 showing an alternative embodiment of a key tag holder embodying principals of the present invention.

### DETAILED DESCRIPTION OF THE INVENTION

While the present invention is susceptible of embodiment in multiple forms, there is shown in the drawings and will hereinafter be described preferred embodiments of the invention, with the understanding the present disclosure is to be considered as setting forth exemplifications of the invention which are not intended to limit the invention to the specific embodiments illustrated and described.

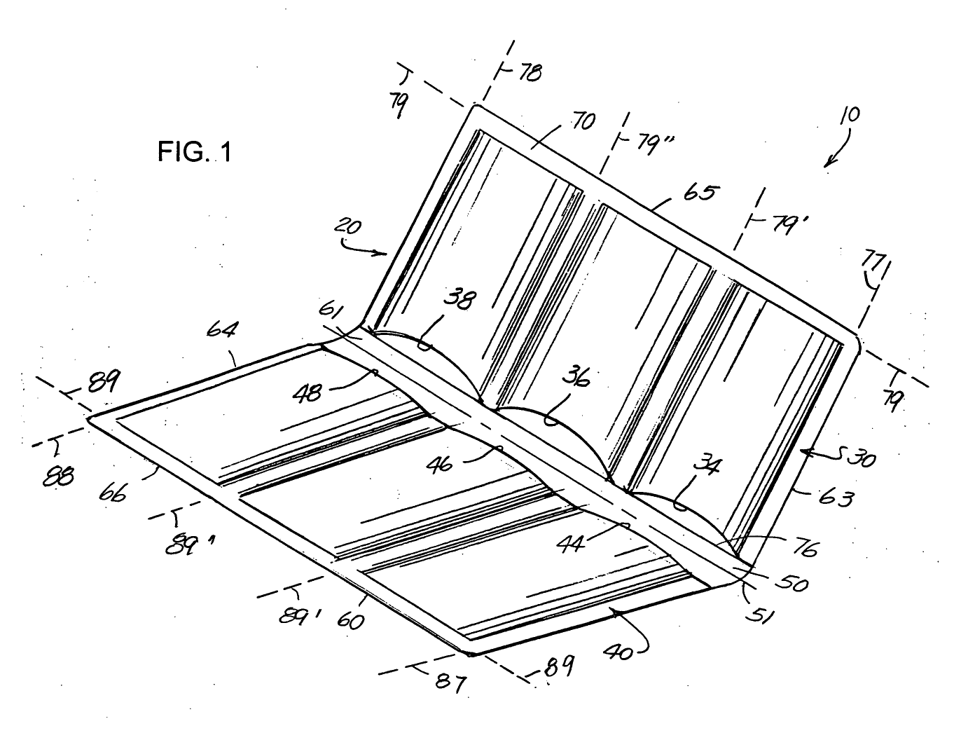

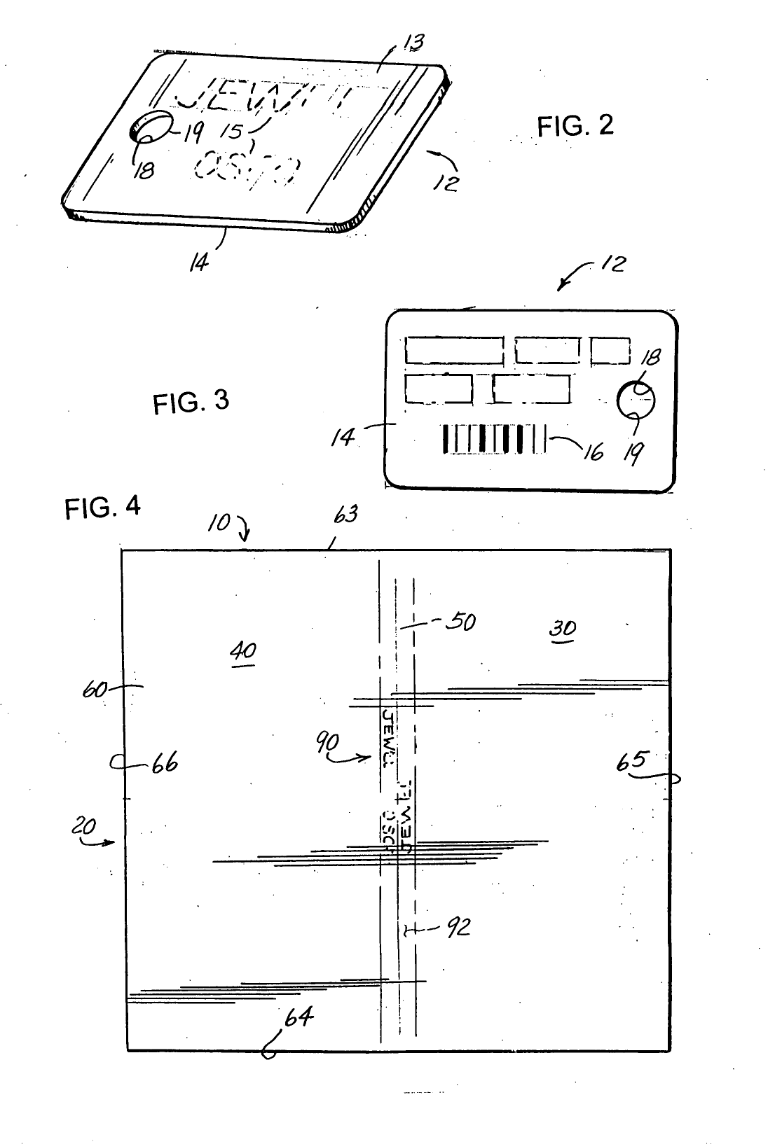

Referring now to the drawings, wherein like reference numerals indicate like parts throughout the several view, there is shown in FIG. 1 one form of key tag holder, generally indicated by reference numeral 10. The key tag holder 10 is substantially transparent and is used to display and hold a multitude of conventional key tags, generally indicated in FIG. 2 by reference numeral 12, now in common usage and supplied by different service providers.

As shown by way of example in FIG. 2, key tag 12 typically has a generally rectangular configuration and includes two major surfaces 13 and 14. One surface 13 of tag 12 is usually provided with suitable indicia, generally indicated by reference numeral 15, including the name and/or logo and/or other identifying information relating to the particular service provider supplying the tag. As shown in FIG. 3, the other surface 14 of tag 12 is typically imprinted with a machine readable bar code 16 including identifying personal information relating the particular owner of the key tag 12. When key tag 12 is moved across a suitable reader (not shown), the service provider gleans information relating to the particular owner of the key tag, i.e. information relating to their purchases at the particular store, and etc. Additional personal information can also be provided on the tag 12. To allow the tag 12 to be attached to a key ring or key chain (not shown), a suitable shaped hole or opening 18, having a closed margin 19, is usually provided adjacent to one edge of the tag 12.

The conventional key tag 12 shown in FIGS. 2 and 3 is typically fabricated from a plastic-like material and has perimeter dimensions ranging in one direction between about 1.0625 inches and about 1.125 inches and in a second direction between about 2.125 and about 3.375. Moreover, the conventional key tag 12 shown FIGS. 2 and 3 is approximately 10 mils thick.

Returning to FIG. 1, key tag holder 10 includes a one-piece generally rectangular bifoldable binder 20 having a first flexible and transparent key tag carrying section 30 and a second flexible and transparent key tag carrying section 40. The key tag holder 10 also includes a center section 50 which serves as a flexible joint and hingedly joins the key tag carrying sections 30, 40. Flexible joint 50 defines a predetermined axis 51 about which the transparent key tag carrying sections 30 and 40 can be folded in overlying and generally flat relation relative to each other. Preferably, the flexible joint 50 is laterally disposed proximately midway or centrally between the key tag carrying sections 30 and 40 of binder 20.

In a preferred embodiment shown in FIGS. 1 and 4, key tag holder 10 is fabricated from a rectangular shaped backing sheet 60 formed from a suitable transparent and substantially clear thermoplastic composition such as a polyvinyl material and the art known equivalents thereto. The backing sheet 60 is about 8 to 10 mils thick and, thus, is flexible. Moreover, backing sheet 60 has a top edge 63, a bottom edge 64 extending generally parallel to the top edge 63, along with first and second generally parallel side edges 65 and 66 laterally spaced apart by a predetermined lateral distance.

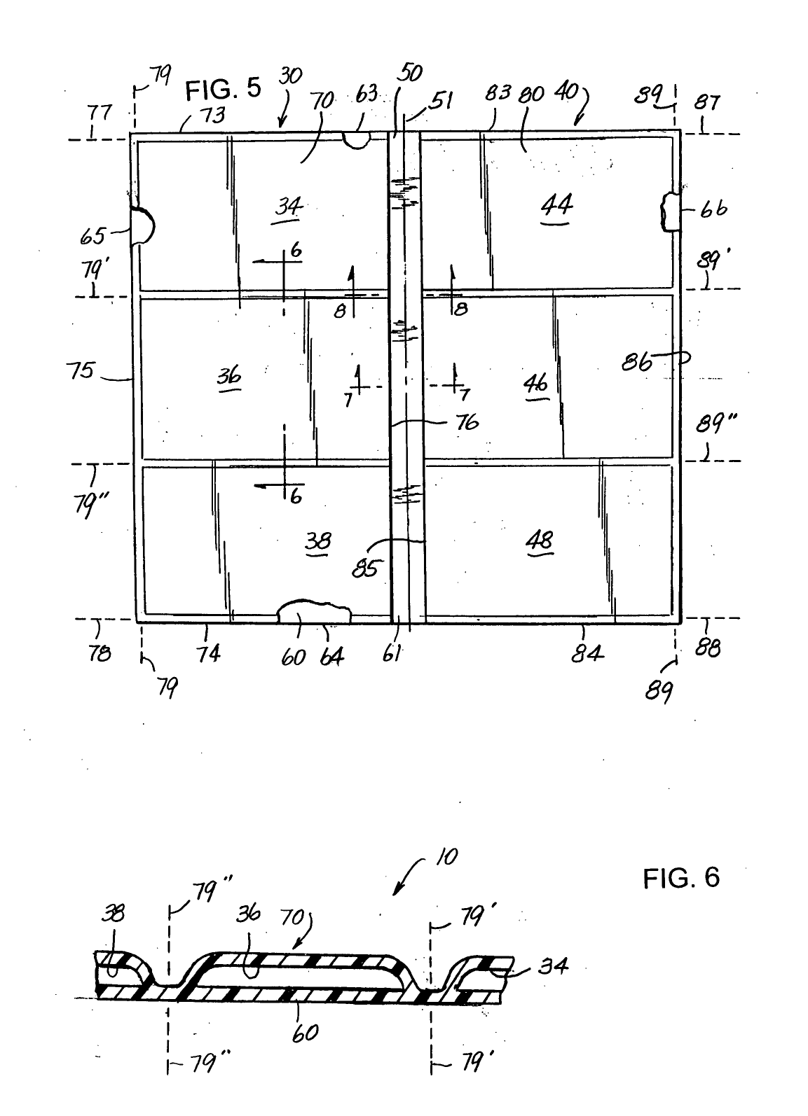

Turning to FIG. 5, and to form the first key tag carrying section 30 of holder 10, a first transparent and generally rectangular panel 70 is arranged in overlying relation and is secured to the backing sheet 60. Panel 70 is fabricated from a suitable transparent and substantially clear thermoplastic composition such as a polyvinyl material and the art known equivalents thereto. Preferably, panel 70 is about 8 to 10 mils thick and, thus, is soft and flexible. In its illustrated form, panel 70 has a top edge 73 and a bottom edge 74 preferably extending generally parallel relative to each other. In one form, the distance separating the top and bottom edges 73 and 74, respectively, of panel 70 is substantially equivalent to a distance separating the top and bottom edges 63 and 64, respectively, of backing sheet 60.

As shown in FIG. 5, panel 70 also includes a pair of generally parallel side edges 75, 76. Notably, side edges 75, 76 of panel 70 are separated by a lateral distance sightly less than one half the lateral distance separating the side edges 65, 66 of backing sheet 60. When panel 70 and backing sheet 60 are secured in overlying relation relative to each other, the top, bottom and side edges 63, 64 and 65, respectively of backing panel 60 are substantially aligned with the top, bottom, and side edges 73, 74 and 75, respectively, of panel 70. As such, a center portion of backing sheet 60 extends laterally beyond edge 76 of panel 70 after backing sheet 60 and panel 70 are secured to each other.

As shown in FIG. 5, panel 70 is secured or joined to backing sheet 60 adjacent three peripheral edges thereof. Backing sheet 60 and panel 70 are joined using any of several known techniques along lines 77-77, 78-78, and 79-79. Additionally, and as shown in FIGS. 5 and 6, backing sheet 60 and panel 70 are also joined using any of several known techniques along lines 79′-79′ and 79″-79″ whereby forming a plurality of transparent pockets 34, 36 and 38 for the first key tag carrying section 30 of key tag carrying holder 10. Notably, each pocket 34, 36 and 38 of card carrying section 30 opens toward the center section 50 of binder 20. The known techniques for securing panel 70 and backing sheet 60 in joined relation can include sewing, gluing, sonic or press welding, or other suitable techniques well known in the art.

In a preferred form, pockets 34 and 36 share a common joinder along lines 79′-79′. Similarly, pockets 36 and 38 share a common joinder along lines 79″-79″. Line 79-79 is a common end for all three transparent pockets 34, 36 and 38. Each pocket 34, 36 and 38 is slightly wider and slightly longer than a conventional key tag 12 adapted to be inserted into any of the three pockets. In one form, each pocket 34, 36 and 38 preferably defines an opening which is about 0.062 inches wider than a conventional key tag 12 and preferably about 0.250 inches longer than a conventional tag 12.

As shown in FIG. 5, and to form the second key tag carrying section 40 of holder 10, a second transparent and generally rectangular panel 80 is arranged in overlying relation and is secured to backing sheet 60. Panel 80 is fabricated from a suitable transparent and substantially clear thermoplastic composition such as a polyvinyl material and the art known equivalents thereto. Preferably, panel 80 is about 8 to 10 mils thick and, thus, is flexible and soft. In the illustrated form, panel 80 has a top edge 83 and a bottom edge 84 extending generally parallel relative to each other. In one form, the distance separating the top and bottom edges 83 and 84, respectively, of panel 80 is substantially equivalent to a distance separating the top and bottom edges 63 and 64, respectively, of backing sheet 60.

As shown in FIG. 4, panel 80 also includes a pair of generally parallel side edges 85, 86. Notably, the side edges 85, 86 of panel 80 are separated by a lateral distance sightly less than one half the lateral distance separating the side edges 65, 66 of backing sheet 60. When panel 80 and backing sheet 60 are secured in overlying relation relative to each other, the top, bottom and side edges 63, 64 and 66, respectively of backing sheet 60 are substantially aligned with the top, bottom, and side edges 83, 84 and 86, respectively, of panel 70. As such, a center portion of backing sheet 60 extends laterally beyond edge 85 of panel 70 after backing sheet 60 and panel 70 are secured to each other.

As shown in FIG. 5, panel 80 is secured or joined to the backing sheet 60 adjacent three edges thereof. Backing sheet 60 and panel 80 are joined together using any of several known techniques along lines 87-87, 88-88, and 89-89. Additionally, backing sheet 60 and panel 80 are also joined using any of several known techniques along lines 89′-89′ and 89″-89″ whereby forming a plurality of transparent pockets 44, 46 and 48 in the first key tag carrying section 40 of the key carrying holder 10. Notably, each transparent pocket 44, 46 and 48 of card carrying section 40 opens toward the center section 50 of the binder 20. The known techniques for securing panel 80 and backing sheet 60 in joined relation can include sewing, gluing, sonic or press welding, and/or other suitable and well techniques well known in the art.

In a preferred form, pockets 44 and 46 share a common joinder along lines 89′-89′. Similarly, pockets 46 and 48 share a common joinder along lines 89″-89″. Line 89-89 is a common end for all three pockets 44, 46 and 48. Each pocket 44, 46 and 48 is slightly wider and longer than a conventional key tag 12 adapted to be inserted into any one of the three pockets. Preferably, each pocket 44, 46 and 48 defines an opening which is about 0.062 inches wider than a conventional key tag 12 and about 0.250 inches longer than a conventional tag 12.

Of course, and depending upon the number of key tags to be carried in the holder 10, any number of additional pockets can be added to the first and second key tag carrying section 30 and 40, respectively, of holder 10 in like manner simply by expanding the distance between the top and bottom edges 63 and 64, respectively, of backing sheet 60 along with the distance between the top and bottom edges 73, 83 and 74, 84 of panels 70 and 80 while adding common joinder lines in a manner similar to that discussed above. Alternatively, the lateral distance between the side edges 65 and 66 could also be increased to provide a third key tag section and, thus, providing a tri-fold binder for carrying the key tags without considerable design effort. Providing a bifoldable key tag holder with key tag carrying sections 30, 40 each having three pockets, however, provides an optimal size for the holder 10 whereby allowing it to readily fit within any wallet or purse.

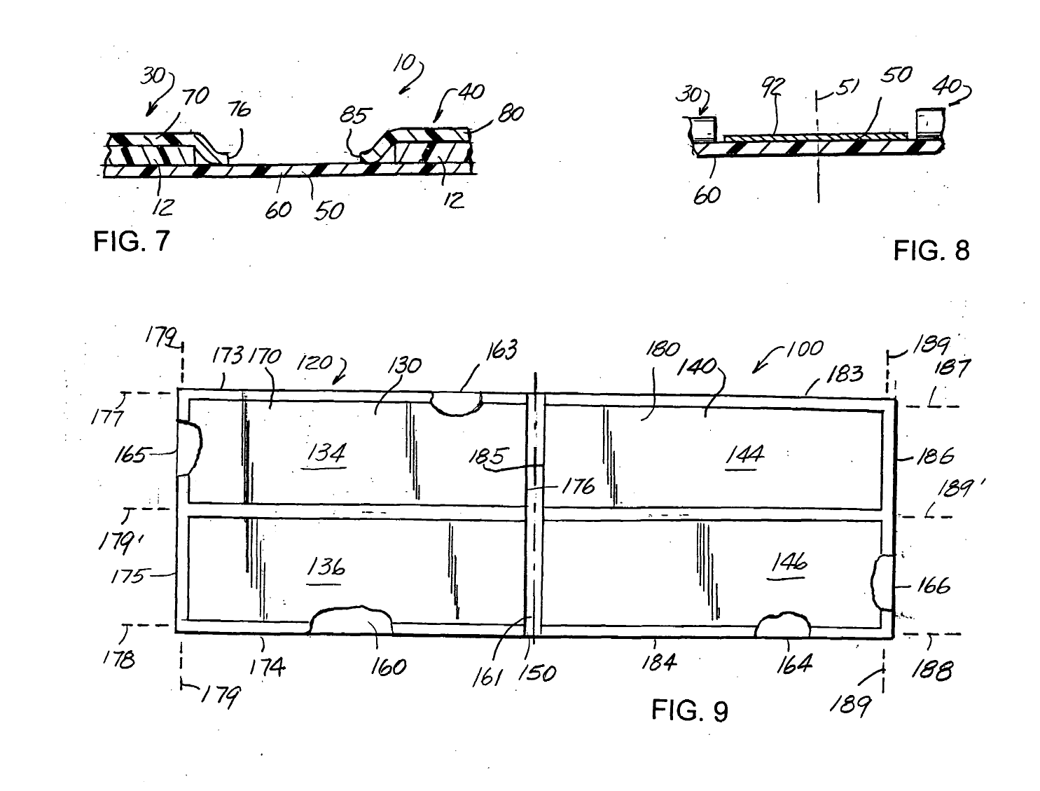

Turning to FIG. 7, the transparent pockets of key tag carrying sections 30, 40 are each preferably configured to promote retention of the key tag 12 within each pocket. As mentioned, each pocket comprising each key tag carrying section 30, 40 of holder 10 is preferably configured to be longer than a conventional key tag by about 0.250 inches. As such, and after the key tag 12 is fully inserted within a pocket, a free edge 76, 85 of each overlying panel 70, 80 tends to fold over the edge of the key tag adjacent to the center section 50 of the holder 10. One of characteristics of the material from which holder 10 is made is that it tends to releasably adhere to itself. Accordingly, the inner surface of the free edge 76, 85 of each overlying panel 70, 80 tends to adhere to the center portion of the inner surface of backing sheet 80 whereby releasably securing the key tag within the pocket. Of course, the free edge 76, 85 of the overlying panel 70, 80 can be readily and easily peeled from the backing sheet 60 when the key tag 12 is to be removed or replaced.

As shown in FIG. 5, key tag holder 10 is preferably imprinted with indicia or logo, generally indicated by reference numeral 90, for advertising a particular service provider in combination with the key tag holder 10. In a preferred embodiment, and such that neither the indicia 15 nor the bar code 16 (FIGS. 2 and 3) on any of the key tags arranged within the transparent pockets 34, 36, 38, 44, 46 or 48 (FIG. 5) is obstructed or otherwise interfered with, the advertising indicia 90 is preferably imprinted along the center section 50 of the holder 10 between the key tag carrying sections 30 and 40. In a preferred embodiment, the indicia 90 is printed on an exterior or outer surface of the backing sheet 60.

To potentially enhance and preferably compliment the indicia or logo 90 imprinted along the center section 50 of holder 10, and as shown in FIG. 8, an inner surface of backing sheet 60, along the center section 50 of holder 10, is preferably imprinted or otherwise provided with an opaque strip 92 preferably extending between the top and bottom edges 63 and 64, respectively, of the backing sheet 60 (FIG. 4). In a preferred form, the opaque strip 92 can be any color or can be color coordinated with any particular color used to imprint the indicia/logo 90 on the holder 10. In either instance, the strip 92 will draw immediate attention to the indicia 90 on the holder 10, and because it is preferably limited in size to only the center section 50 of the binder 20, will not interfere or hide any important portion of the key tags in the any of the transparent pockets 34, 36, 38, 44, 46 or 48 of holder 10.

FIG. 9 illustrates an alternative form of key tag holder. This alternative form of key tag holder is designated generally by reference numeral 100. The elements of this alternative key tag holder that are functionally analogous to those elements discussed above regarding key tag holder 10 are designated by reference numerals identical to those used above with the exception this embodiment uses reference numerals in the 100 series.

Key tag holder 100 preferably includes a one-piece generally rectangular binder 120 having a first flexible and transparent key tag carrying section 130 and a second flexible and transparent key tag carrying section 140. In this embodiment, the key tag carrying sections 130, 140 are each configured to releasably accommodate a larger key tag than is illustrated in FIGS. 2 and 3. The key tag holder 100 includes a center section 150 which serves as a flexible joint and hingedly joins the key tag carrying sections 130, 140. Flexible joint 150 permits the key tag carrying sections 130 and 140 to be folded in overlying and generally flat relation relative to each other. Preferably, the flexible joint 150 is laterally disposed proximately midway or centrally between the key tag carrying sections 130 and 140.

Like holder 10, one form of key tag holder 100 is fabricated from a rectangular shaped backing sheet 160 fabricated from a transparent and substantially clear thermoplastic composition such as a polyvinyl material and the art known equivalents thereto. The backing sheet 160 is about 8 to 10 mils thick and, thus, is flexible and soft. Moreover, backing sheet 160 has a top edge 163, a bottom edge 164 extending generally parallel to the top edge 163, along with first and second generally parallel side edges 165 and 166 laterally spaced apart by a predetermined lateral distance.

To form key tag carrying section 130 of holder 100, a first transparent and generally rectangular panel 170 is arranged in overlying relation and is secured to the backing sheet 160. Panel 170 is fabricated from a suitable transparent and substantially clear thermoplastic composition such as a polyvinyl material and the art known equivalents thereto. Preferably, panel 170 is about 8 to 10 mils thick and, thus, is soft and flexible. Panel 170 preferably has a top edge 173 and a bottom edge 174 extending generally parallel relative to each other. In one form, the distance separating the top and bottom edges 173 and 174, respectively, of panel 170 is substantially equivalent to a distance separating the top and bottom edges 163 and 164, respectively, of backing sheet 160.

Panel 170 also includes a pair of generally parallel side edges 175, 176. Notably, side edges 175, 176 of panel 170 are separated by a lateral distance sightly less than one half the lateral distance separating the side edges 165, 166 of backing sheet 160. Thus, when panel 170 and backing sheet 160 are secured in overlying relation relative to each other, the top, bottom and side edges 163, 164 and 165, respectively, of backing panel 160 are substantially aligned with the top, bottom, and side edges 173, 174 and 175, respectively, of panel 170. As such, a laterally center portion 151 of backing sheet 160 extends laterally beyond edge 176 of panel 70 after backing sheet 160 and panel 170 are secured to each other.

Panel 170 is secured or joined to backing sheet 160 adjacent three peripheral edges thereof. Backing sheet 160 and panel 170 are joined using any of several known techniques along lines 177-177, 178-178, and 179-179. Additionally, backing sheet 160 and panel 170 are also joined using any of several known techniques along lines 179′-179′ whereby forming two transparent pockets 134, 136 for the first key tag carrying section 130 of key tag carrying holder 100. Notably, pockets 134 and 136 of card carrying section 30 opens toward the lateral center of backing sheet 160. The known techniques for securing panel 170 and backing sheet 160 in joined relation are the same as discussed above.

In a preferred form, pockets 134 and 136 of key tag holder 100 share a common joinder along line 179′-179′. Joinder line 177-177 is a common end for the transparent pockets 134 and 136. As discussed above, each pocket 134 and 136 is slightly wider and slightly longer than most larger conventional key tags adapted to be inserted into any of the pockets. In one form, each pocket 134 and 136 preferably defines an opening which is about 0.062 inches wider than a most larger conventional key tag and, preferably, about 0.250 inches longer than a most larger conventional key tags.

To form the second key tag carrying section 140 of holder 100, a second transparent and generally rectangular panel 180 is arranged in overlying relation and is secured to backing sheet 160. Panel 180 is fabricated from a suitable transparent and substantially clear thermoplastic composition such as a polyvinyl material and the art known equivalents thereto. Preferably, panel 180 is about 8 to 10 mils thick and, thus, is flexible and soft. Panel 80 preferably has a top edge 183 and a bottom edge 184 extending generally parallel relative to each other. In this form, the distance separating the top and bottom edges 183 and 184, respectively, of panel 180 is substantially equivalent to a distance separating the top and bottom edges 163 and 164, respectively, of backing sheet 160.

Panel 180 also includes a pair of generally parallel side edges 185, 186. Notably, the side edges 185, 186 of panel 180 are separated by a lateral distance sightly less than one half the lateral distance separating the side edges 165, 166 of backing sheet 160. When panel 180 and backing sheet 160 are secured in overlying relation relative to each other, the top, bottom and side edge 163, 164 and 166, respectively of backing sheet 160 are substantially aligned with the top, bottom, and side edge 183, 184 and 186, respectively, of panel 180. As such, a lateral center portion of backing sheet 160 extends laterally beyond edge 185 of panel 180 after backing sheet 160 and panel 180 are secured to each other.

As shown in FIG. 9, panel 180 is secured or joined to the backing sheet 160 adjacent three edges thereof. Backing sheet 160 and panel 180 are joined together using any of several known techniques along lines 187-187 and 188-188. Additionally, backing sheet 160 and panel 180 are also joined using any of several known techniques along lines 189′-189′ whereby forming a two transparent pockets 144, 146 in the key tag carrying section 140 of the key carrying holder 100. Notably, the transparent pockets 144 and 146 of key tag carrying section 140 opens toward the center section 150 of binder 120. The known techniques for securing panel 180 and backing sheet 160 in joined relation are the same as discussed above.

Preferably, pockets 144 and 146 of key tag holder 100 share a common joinder along lines 189′-189′. Line 189-189 is a common end for both pockets 144 and 146. In a preferred form, each pocket 144 and 146 is slightly wider and longer than a larger conventional key tag adapted to be inserted into any one of the pockets. Preferably, pockets 144 and 146 each define an opening which is about 0.062 inches wider than a larger conventional key tag and about 0.250 inches longer than a larger conventional tag.

Either embodiment of the invention illustrated in the drawings and discussed above can be used in the following manner. A conventional key tag is inserted into one of the plurality of transparent pockets of the key tag holder. Because the pockets are transparent on both sides, the key tag can be inserted as desired by the owner with a bar code on the key tag facing inwardly or outwardly of the key tag holder.

The foldability of the key tag holder offers many unique advantages. First, it significantly increases the number of key tags which can be carried in the holder. Second, it significantly reduces clutter on the key ring/key chain of the owner. Moreover, the folded size of the key tag holder allows it to be readily and securely carried in a person's purse or wallet without either bulk or weight. Additionally, the key tag holder neatly organizes and readily allows the owner to present any one of several different key tags when required or desired. Because each pocket is open on one side, any one of the different key tags is readily accessible from the holder when needed or desired.

Because each pocket preferably opens toward the center of the bifoldable one-piece binder, the likelihood of a key tag inadvertently falling or slipping out of a pocket in the holder is substantially reduced. The ability to significantly reduce the likelihood of inadvertently losing one or more of the key tags can save the owner considerable time and reduce the time otherwise wasted in having to return to the service provider to retrieve and complete those forms necessary to obtain a replacement key tag. Moreover, the ability of the service provider to imprint their advertisement or logo on a unique key tag holder will only serve to promote sales of that service provider wherever the key tag holder owner travels and uses the holder.

From the foregoing, it will be observed that numerous modifications and variations can be made and effected without departing or detracting from the true spirit and novel concept of the present invention. Moreover, it will be appreciated, the present disclosure is intended to set forth an exemplification of the invention which is not intended to limit the invention to the specific embodiment illustrated. Rather, this disclosure is intended to cover by the appended claims all such modifications and variations as fall within the spirit and scope of the claims.

1. A key tag holder for holding and readily displaying a plurality of different key tags each having a machine readable code for a particular service provider thereon, said key tag holder comprising:
a generally rectangular backing sheet having generally parallel top and bottom edges, along with first and second generally parallel side edges spaced a predetermined lateral distance apart, and with said backing sheet being formed from a flexible and substantially clear material;
a first substantially clear and generally rectangular panel arranged in overlying relation and secured to an inner surface of said backing sheet adjacent the top, bottom and said first side edge thereof, with said first substantially clear panel having a width less than one-half the lateral distance between the first and second side edges of said backing sheet, and wherein said first transparent panel combines with said backing sheet to form a plurality of substantially identical pockets defining a first key tag carrying section of said key tag holder, with each pocket having three closed sides, wherein said generally rectangular panel and said backing sheet are joined together, and an open side opening to a lateral center portion of said backing sheet, and with each pocket in said first key tag carrying section being sized to receive and hold one of said key tags therewithin such that the machine readable code on said key tag received within any pocket is clearly readable from either side of the key tag holder; and
a second substantially clear and generally rectangular panel arranged in overlying relation and secured to the inner surface of said backing sheet adjacent the top, bottom and said second side edge thereof, with said second substantially clear panel having a width equal to that of the first panel and less than one-half the lateral distance between the first and second side edges of said backing sheet, and wherein said second transparent panel combines with said backing sheet to form a plurality of substantially identical pockets defining a second key tag carrying section of said key tag holder, with each pocket having three closed sides, wherein said second transparent and generally rectangular panel and said backing sheet are joined together, and an open side opening to the lateral center portion of said backing sheet, and with each pocket in said second key tag carrying section being sized to receive and hold another of said key tags therewithin such that the machine readable code on said key tag received within any pocket is readable from either side of the key tag holder; and
wherein said key tag holder further includes a flexible joint disposed centrally between said first and second key tag carrying sections and defining a predetermined axis extending generally normal to the top and bottom edges of said backing sheet and about which said first and second key tag carrying sections are foldable upon each other such that the first and second side edges of said backing sheet are arranged in aligned superimposed relation when said first and second key tag carrying sections are folded upon each other whereby inhibiting tearing and related damages to the key tag holder, and with the folded sections of said key tag holder ranging in lateral width between about 2.25 inches and about 3.625 inches.

2. The key tag holder according to claim 1, wherein each key tag carrying section is formed with at least three substantially clear pockets for holding at least three different key tags.

3. The key tag holder according to claim 1, wherein each key tag carrying section is formed with an equal number of substantially clear pockets.

4. The key tag holder according to claim 1, further including an opaque area extending between the top and bottom edges of the backing sheet along the flexible joint, and wherein indicia associated with a particular service provider is imprinted on said backing sheet in operable combination with said opaque area.

5. The key tag holder according to claim 1, wherein said backing sheet and said first panel are joined to each other such that at least one pocket of the first key tag carrying section has a peripheral closed edge joined in common with a peripheral closed edge of at least one other pocket of the first key tag carrying section.

6. The key tag holder according to claim 1, wherein said backing sheet and said second panel are joined to each other such that at least one pocket of the second key tag carrying section has a peripheral closed edge joined in common with a peripheral closed edge of at least one other pocket of the second key tag carrying section.

7. A key tag holder for holding and readily displaying a plurality of different key tags, with each key tag having a machine readable code for a particular service provider thereon, said key tag holder comprising:
first and second substantially identical key tag carrying sections joined to each other along a centralized flexible joint defining a predetermined axis extending generally across said key tag holder in parallel relation to opposed side edges of said key tag holder and about which said first and second key tag carrying sections are foldable into overlying and generally flat relation relative to each other, and with the predetermined axis about which said first and second key tag carrying sections fold being arranged relative to the key tag carrying sections such that, when said key tag sections are folded upon each other, outer edges of the key tag carrying sections are arranged in superimposed aligned relation relative to each other whereby inhibiting tearing and related damage to the key tag holder, with each key tag carrying section including a plurality of adjacent and substantially clear pockets each sized to receive and hold one of the different key tags therein, with the clarity of each pocket permitting the machine readable code on each key tag to be readable from either side of the pocket within which said key tag is received, and with each pocket of each key tag carrying section having superimposed inner and outer layers of flexible plastic material and a generally rectangular configuration sized relative to the key tags to be received and held therewithin and which is closed along three sides and opens to the area wherein said key tag sections are joined, with the inner layer of plastic material forming each pocket being slightly longer than a length of a key tag to be inserted therewithin, and with that portion of the inner lever of plastic material extending beyond the key tag inserted into said pocket being arranged in operable combination with an inner surface on the outer layer of material of said respective pocket whereby releasably closing the open end of the respective pocket after said key tag is inserted thereinto so as to inhibit inadvertent loss of a key tag from said pockets.

8. The key tag holder according to claim 7, wherein each key tag carrying section is formed with at least three substantially clear pockets for holding at least three different key tags.

9. The key tag holder according to claim 7, wherein each key tag carrying section is formed with an equal number of substantially clear pockets.

10. The key tag holder according to claim 7, wherein at least one pocket of the first key tag carrying section has a peripheral closed edge joined in common with a peripheral closed edge of at least one other pocket of the first key tag carrying section.

11. The key tag holder according to claim 7, wherein at least one pocket of the second key tag carrying section has a peripheral closed edge joined in common with a peripheral closed edge of at least one other pocket of the second key tag carrying section.

12. (canceled)

13. The key tag holder according to claim 7, wherein the flexible joint is provided with an opaque area extending parallel to the flexible joint, and wherein indicia associated with a particular service provider is imprinted on said key tag holder in operable combination with said opaque area.

14. A key tag holder for holding and readily displaying a plurality of different key tags with each key tag having a predetermined width and machine readable code for a particular service provider thereon, said key tag holder comprising:
a one-piece binder having a first flexible and clear plastic key tag carrying section, a second flexible and clear plastic key tag carrying section which is substantially identical to the first key tag carrying section, and a flexible joint disposed between the first and second key tag carrying sections, with said flexible joint defining a predetermined axis such that, when said first and second key tag carrying sections are folded in overlying and generally flat relation relative to each other, with a folded width of said key tag holder ranging between about 2.25 inches and about 3.625 inches, and with outer edges of said first and second key tag carrying sections of said key tag holder are arranged in superimposed and aligned relation relative to each other whereby inhibiting tearing and related damage to the key tag holder, and wherein an inner surface of each key tag carrying section has a plurality of transparent rectangularly shaped pockets each of which is sized to snugly receive and accommodate one of said different key tags therewithin, with each pocket being closed about three sides and opening on a fourth side to the predetermined axis of said binder, and with the transparency of each pocket on said first and second key tag carrying sections permitting the machine readable code on each key tag to be readable from either side of the pocket within which said key tag is received; and
wherein an opaque area is provided on said key tag holder, with said opaque area extending generally parallel and limited to an area of said flexible joint between opposed edges of said key tag holder, with indicia associated with a particular service provider being imprinted on said key tag holder in operable combination with said opaque area.

15. The key tag holder according to claim 14, wherein each key tag carrying section is formed with at least three substantially clear pockets for holding at least three different key tags.

16. The key tag holder according to claim 14, wherein each key tag carrying section is formed with an equal number of substantially clear pockets.

17. The key tag holder according to claim 14, wherein at least one pocket of each key tag carrying section has a peripheral closed edge joined in common with a peripheral closed edge of at least one other pocket of the same key tag carrying section.

18. The key tag holder according to claim 14, further including a generally rectangular, flexible and clear plastic backing sheet which is common to both of said first and second key tag carrying sections, with said backing sheet having a top edge, a bottom edge, along with first and and second generally parallel side edges, with said backing sheet defining said flexible joint between said first and second key tag carrying sections.

19. (canceled)
